(19) United States
(12) Patent Application Publication
(10) Pub. No.: US 2008/0008057 A1
(43) Pub. Date: Jan. 10, 2008

(54) OPTICAL DISC APPARATUS AND INFORMATION RECORDING/REPRODUCING METHOD OF THE SAME

(76) Inventors: Nobuhiro Takeda, Tokyo (JP); Mitsuru Harai, Tokyo (JP); Toshitaka Nakashima, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/625,385

(22) Filed: Jan. 22, 2007

(30) Foreign Application Priority Data
Jul. 10, 2006 (JP) 2006-188923

(51) Int. Cl. G11B 7/00

(52) U.S. Cl. 369/44.23

(57) ABSTRACT

An optical disc apparatus is designed to perform focus control of an objective lens of an optical pickup by generating a first focus error signal of an astigmatism method from a signal based on 0-order light of a reflected laser beam, as well as generating a second focus error signal of a differential astigmatism method from the signal based on the 0-order light and from a signal based on ±1-order light. The focus control of the objective lens is performed by the second focus error signal during recording or reproducing operation within a recording layer of an optical disc. The focus control is performed by the first focus error signal when a focus jump is performed in response to switching of the recording layer of the optical disc.

### CLAIM OF PRIORITY

The present application claims priority from Japanese application serial No. P2006-188923, filed on Jul. 10, 2006, the content of which is hereby incorporated by reference into this application.

### BACKGROUND OF THE INVENTION

1. Technical Field of the Invention

The present invention relates to an optical disc apparatus, and particularly to a focus control technology for recording or reproducing information onto/from an optical disc having plural recording layers.

2. Description of the Related Art

In an optical disc apparatus, focus control of an objective lens of an optical pickup has been performed using a focus error signal based on an astigmatism method, or a CAD (Conventional Astigmatism Detection) method that generates a focus error signal by detecting 0-order light of a reflected laser beam having passed through the objective lens and performing an addition/subtraction operation on the 0-order light, as well as using a focus error signal based on a differential astigmatism method, or a DAC (Differential Astigmatism Detection) method that generates a focus error signal by detecting the 0-order light and ±1-order light of the reflected laser beam having passed through the objective lens and performing an addition/subtraction operation on the 0-order light and the ±1-order light. With the CAD method, as shown in FIG. 6A, an unnecessary laser beam is not detected when the objective lens is swept upward or downward relative to an optical disc having plural recording layers. Thus it is possible to obtain a signal as a focus error signal without being affected by the unnecessary laser beam. With the DAD method, as shown in FIG. 7B, when a light spot, which is generated by a laser beam on an optical disc surface due to focusing of the objective lens, crosses a recording track with a tracking servo OFF, the leakage of reflected laser beam from adjacent tracks can be prevented. Thus it is possible to perform an accurate focus control.

Further as the related art of the present invention, there are, for example, Japanese Patent Specification No. 3463003 and Japanese Patent Application Laid-Open No. 2005-174421. In Japanese Patent Specification No. 3463003, there is described a technology that performs the focus control of the objective lens based on the focus error signal of the DAD method for a DVD-RAM disc, and that performs the focus control of the objective lens based on the focus error signal of the CAD method for a DVD-ROM disc. In JP-A-2005-174421, there is described a technology for obtaining a focus error signal of the so-called DAD method and a tracking error signal of the so-called differential push-pull method, by providing selection switches in a circuit for adding or subtracting signals from photodetectors each having divided areas thereby to switch so that the divided areas of each of two photodetectors, which are the output sources of signals to be added, belong to the same photodetector, or so that the divided areas of the output sources are across an area belonging to the two photodetectors. In this way it is possible to substantially reduce not only the influence of disturbance on a focus error signal but also the offset occurring in a tracking error signal.

### SUMMARY OF THE INVENTION

In the case of the CAD method, when a light spot, which is generated by a laser beam on an optical disc surface due to focusing of the objective lens with the tracking servo OFF, crosses a recording track, as shown in FIG. 6B, a leakage component of a reflected laser beam from adjacent tracks appears as a pulsating waveform on the focus error signal. With the tracking servo in OFF state as in a seek operation, the stability of the focus control is deteriorated due to the leakage component. In the case of the DAD method, when the objective lens is swept upward or downward in an optical disc having plural recording layers, unnecessary light is generated between the recording layers by sub-spots, and the focus error signal has a waveform including a waveform of the unnecessary light as shown in FIG. 7A. When focus jump control of the objective lens is performed based on the focus error signal including such a waveform of the unnecessary light, as shown in FIG. 8, a slowdown starting level of focus movement of the objective lens (slowdown starting thresh) y₁ and an ending level of focus jumping (jump end thresh) y₂ are generated on the waveform of the unnecessary light. The focus state is in ON state during the period in which the waveform level is below the focus jump ending level y₂, causing a pull-in operation to be performed at a timing of q′ when the focus of the objective lens is not moved from a first recording layer (Layer “0”) to a second recording layer (Layer “1”). In other words, the pull-in is incorrectly performed between the layers. In FIG. 8, reference symbol p′ denotes a timing at which the slowdown in the focus movement of the object lens incorrectly starts due to the waveform of the unnecessary light, p denotes the slowdown start timing of the focus movement of the objective lens in the case of having no waveform of the unnecessary light or having no influence of such a waveform, and q denotes the focus jump end timing of the objective lens in the same case as described above.

Further, neither the technologies described in Japanese Patent Specification No. 3463003 nor JP-A-2005-174421 switches between the DAD method and the CAD method according to the operation mode for the optical disc having plural recording layers.

In view of the circumstances of the related art described above, it is desirable for the optical disc apparatus to constantly perform a focus jump operation of the objective lens as well as a recording/reproducing operation including a seek operation relative to the optical disc having plural recording layers.

The present invention addresses the above described needs by providing an optical disc apparatus having consistent recording/reproduction quality with good usability.

The present invention is a technology that can solve the above described problem and achieves the above described object.

That is, an optical disc apparatus according to the present invention is designed to perform a focus control of an objective lens of an optical pickup by generating a first focus error signal of an astigmatism method (hereinafter referred to as CAD method) from a signal based on 0-order light of a reflected laser beam having passed through the objective lens as well as generating a second focus error signal of a differential astigmatism method (hereafter referred to as DAD method) from the signal based on the 0-order light and from a signal based on ±1-order light. The focus control of the objective lens is performed by the second focus error signal during recording or reproducing operation within a recording layer of an optical disc. The focus control is performed by the first focus error signal when a focus jump is performed in response to switching of the recording layer of the optical disc.

### BRIEF DESCRIPTION OF THE DRAWINGS

FIG. 1 is a block diagram showing an example of an optical disc apparatus as an embodiment of the present invention;

FIG. 2 is a block diagram of a focus control system in the optical apparatus of FIG. 1;

FIG. 3 is a block diagram of focus error signal detection in the optical disc apparatus of FIG. 1;

FIG. 4 is a diagram illustrating a focus jump in the optical disc apparatus of FIG. 1;

FIG. 5 is a diagram of the operation of a focus control in the optical disc apparatus of FIG. 1;

FIGS. 6A and 6B are diagrams showing examples of a focus error signal of the CAD method;

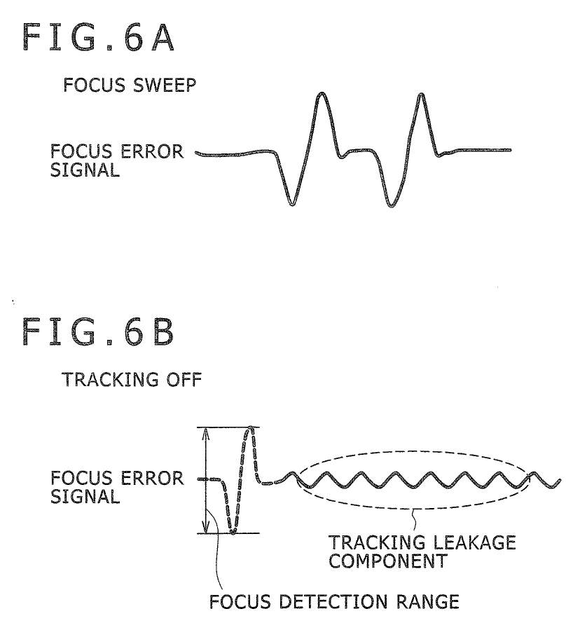

FIGS. 7A and 7B are diagrams showing examples of a focus error signal of the DAD method; and

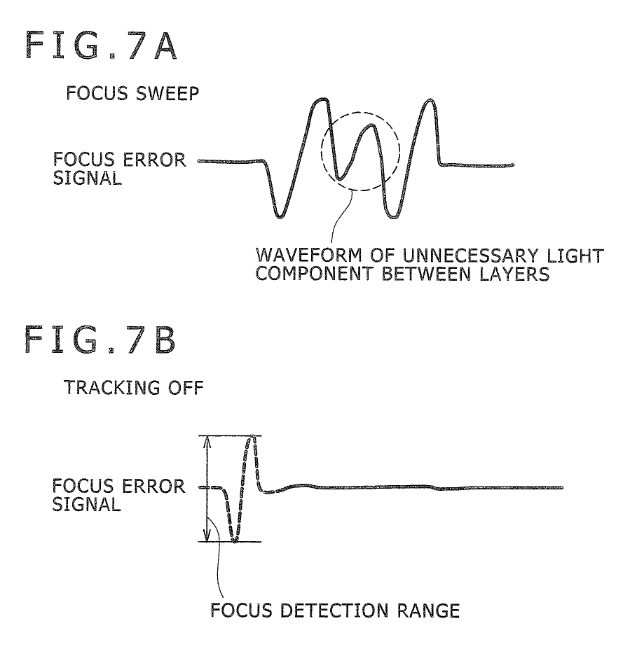

FIG. 8 is a diagram in the case of the focus jump by the focus error signal of the DAD method.

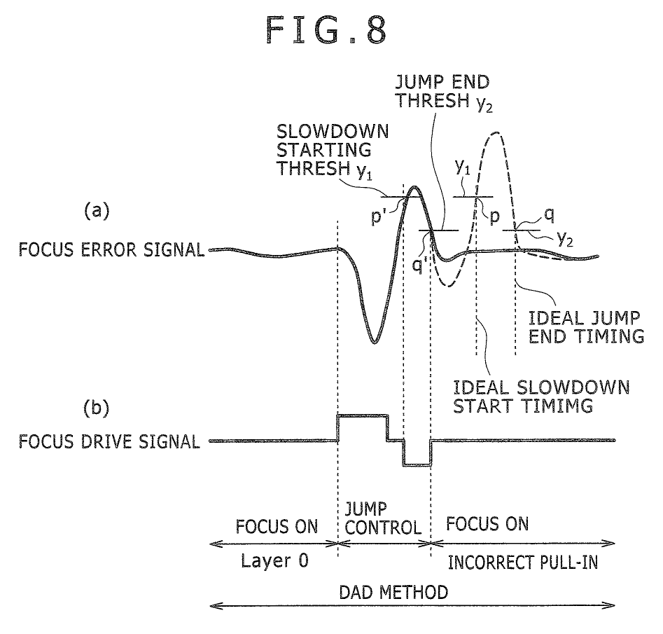

### DETAILED DESCRIPTION OF THE PREFERRED EMBODIMENT

Hereinafter, an embodiment of the present invention will be described with reference to the accompanying drawings.

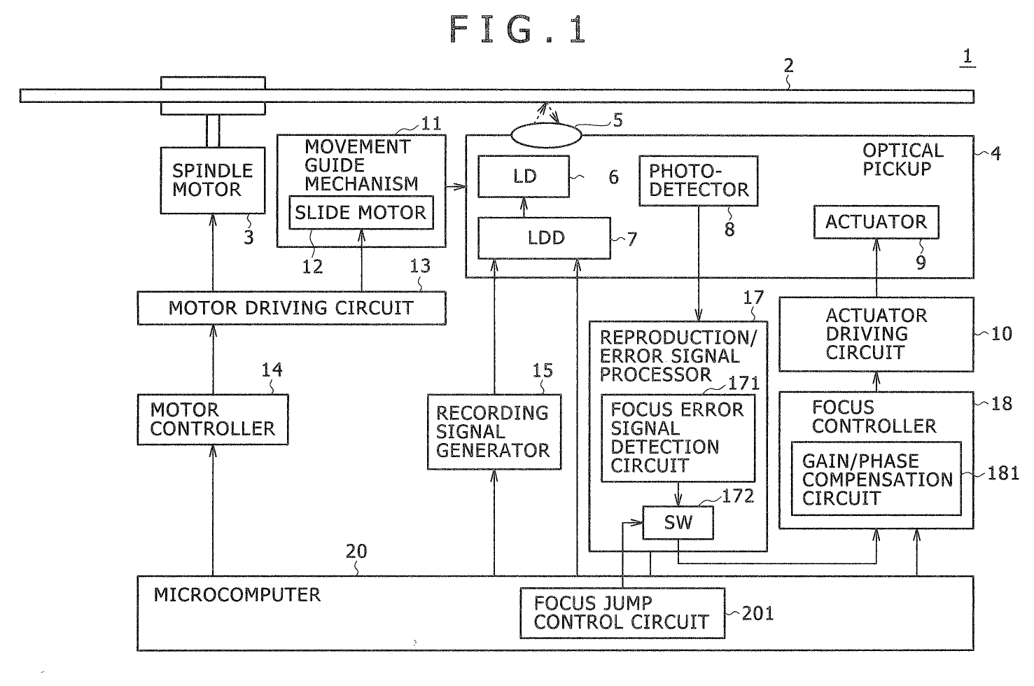

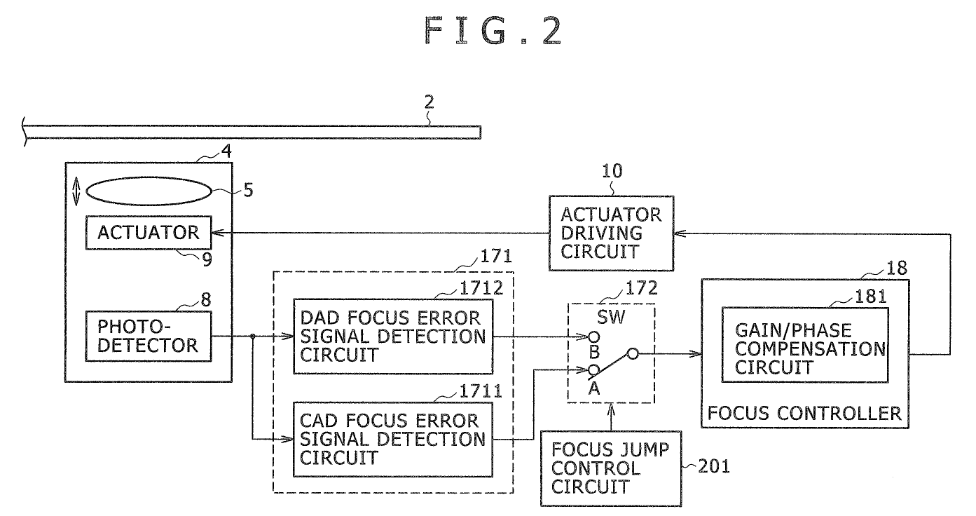

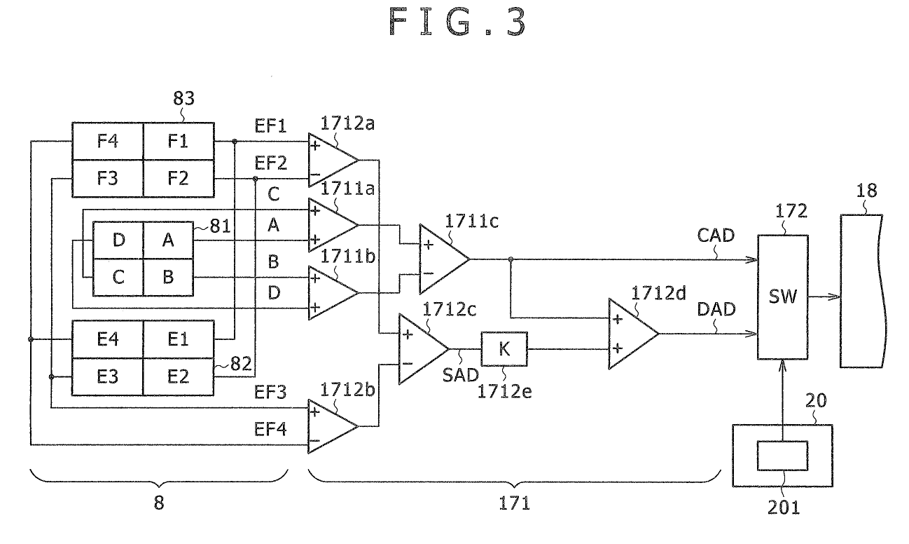

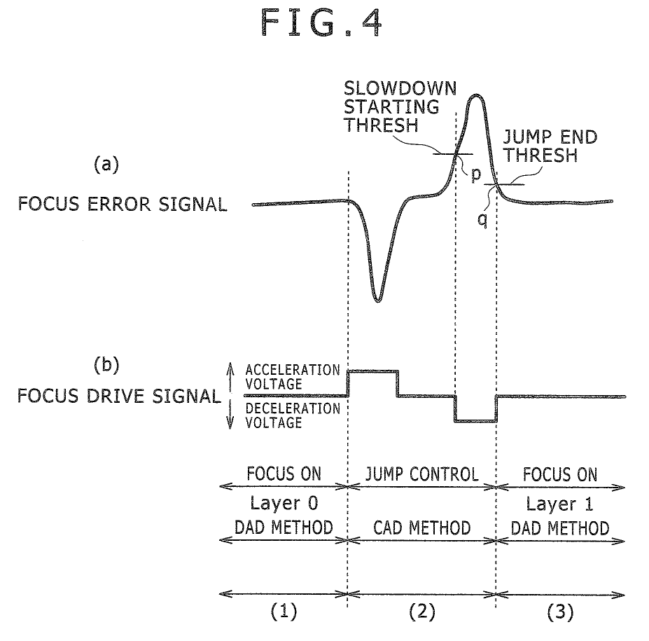

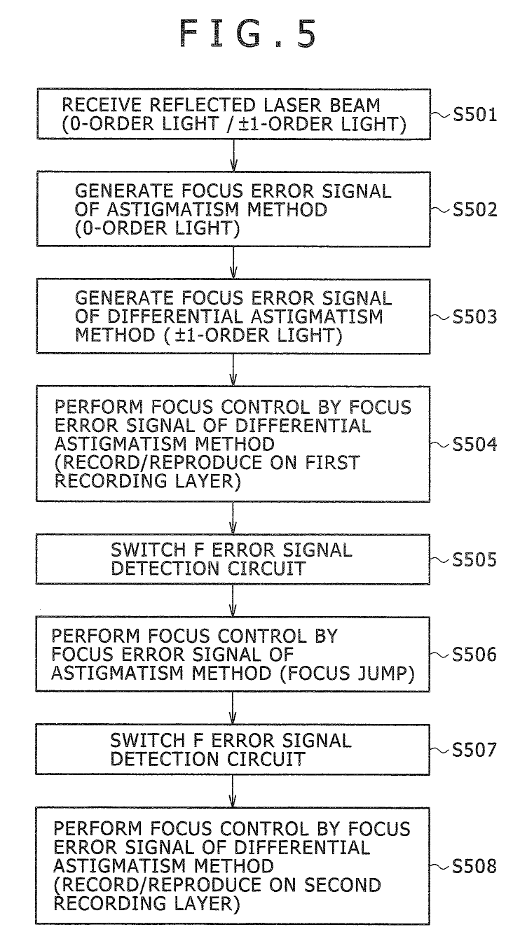

FIGS. 1 to 5 are diagrams of an embodiment of the present invention, in which FIG. 1 is a block diagram of an optical disc apparatus as an embodiment of the invention; FIG. 2 is a block diagram of a focus control system in the optical disc apparatus of FIG. 1; FIG. 3 is a block diagram of focus error signal detection in the optical disc apparatus of FIG. 1; FIG. 4 is a diagram illustrating a focus jump in the optical disc of FIG. 1; and FIG. 5 is a diagram of the operation of a focus control in the optical disc apparatus of FIG. 1.

In FIG. 1, reference numeral 1 denotes an optical disc apparatus as an embodiment of the present invention; 2 denotes an optical disc having plural recording layers such as DVD±R; 3 denotes a spindle motor for rotating and driving the optical disc 2; 4 denotes an optical pickup; 5 denotes an objective lens; 6 denotes a laser diode that generates a laser beam of predetermined power for recording or reproduction within the optical pickup 4; 7 denotes a laser driving circuit for driving the laser diode 6 within the optical pickup 4; 8 denotes a photodetector included in the optical pickup 4 to receive a reflected laser beam from a recording surface of a recording layer of the optical disc 2 (hereinafter referred to as an optical disc surface) via the objective lens 5, convert to an electrical signal and output the electrical signal; 9 denotes an actuator for displacing the objective lens 5 within the optical pickup 4 relative to the optical disc surface and changing the position of the objective lens 5; 10 denotes an actuator driving circuit for driving the actuator 9; 11 denotes a movement guide mechanism having a linear guide member (not shown) and a read screw member (not shown) to move the optical pickup 4 in a substantial radial direction of the optical disc 2; 12 denotes a slide motor included in the movement guide mechanism 11 to rotate and drive the reed screw member (not shown); 13 denotes a motor driving circuit for driving the spindle motor 3 and the slide motor 12; 14 denotes a motor controller for controlling the motor driving circuit 13; 15 denotes a recording signal generator that generates a recording signal for recording information onto the optical disc 2; 17 denotes a reproduction/error signal processor for processing reproduction signals from the photodetector 8 as RF signals, and detecting a tracking error signal for tracking control as well as a focus error signal for focus control, from the reproduction signals; 171 denotes a focus error signal detection circuit included in the reproduction/error signal processor 17 to detect the focus error signals; 172 denotes a switching circuit as a selector included in the focus error signal detection circuit 171 to select one of two focus error signal detection circuits (not shown) of different methods; 18 denotes a focus controller for generating and outputting the focus control signal and tracking control signal for controlling the actuator driving circuit 10; 181 denotes a gain/phase compensation circuit included in the focus controller 18 to adjust the gain and phase in a tracking control system and a focus control system; 20 denotes a microcomputer as a controller for controlling the whole optical disc apparatus 1; and 201 denotes a focus jump control circuit included in the microcomputer 20 to control the switch 172 in the focus jump.

The focus error signal detection circuit 171 includes a first focus error signal detection circuit (not shown) for outputting a focus error signal of the CAD method (first focus error signal) and a second focus error signal detection circuit (not shown) for outputting a focus error signal of the DAD method (second focus error signal).

The switching circuit 172 switches an internal switch in response to a control signal from the focus jump control circuit 201, and selects either the first focus error signal detection circuit or second focus error signal detection circuit within the focus error signal detection circuit 171 so that an output (a focus error signal) of the selected focus error signal detection circuit is input to the side of the focus controller 18.

When the optical disc apparatus 1 records or reproduces information onto/from the optical disc 2 by switching the recording layer, the microcomputer 20 controls the focus controller 18 to cause it to input a control signal for focus jump into the actuator driving circuit 10 so that the objective lens 5 performs the focus jump. At this time, the microcomputer 20 inputs a control signal for controlling the switching circuit 172 from the focus jump control circuit 201 to the switching circuit 172.

The optical disc apparatus 1 uses the focus error signal of the DAD method to perform the focus control during recording or reproducing operation on one recording layer of the optical disc 2, and uses the focus error signal of the CAD method during a focus jump operation that switches the recording layer. In other words, the microcomputer 20 detects the tracking error signal and the focus error signal of the reproduction/error signal processing circuit 17 based on the signals from the photodetector 8 during the recording or reproducing operation. In the focus error signal detection circuit 171, the focus error signal of the CAD method and the focus error signal of the DAD method are detected as the focus error signals. The microcomputer 20 controls the switching circuit 172 to select the focus error signal of the DAD method for the focus control during the recording or reproducing operation. On the other hand, the microcomputer 20 controls the switching circuit 172 to select the focus error signal of the CAD method for the focus control when the focus jump is performed. The tracking control of the objective lens 5 is in OFF state during the focus jump.

It should be understood that the same reference numerals shown in FIG. 1 will be employed as those for denoting the same components of the optical disc apparatus indicated in FIG. 1.

FIG. 2 is a diagram of a focus control system in the optical disc apparatus 1 of FIG. 1.

In FIG. 2, reference numeral 1711 denotes a CAD focus error signal detection circuit (first focus error signal detection circuit) which is included in the focus error signal detection circuit 171 and detects the focus error signal of the CAD method. Reference numeral 1712 denotes a DAD focus error signal detection circuit (second focus error signal detection circuit) which is included in the focus error signal detection circuit 171 and detects the focus error signal of the DAD method.

In the configuration of FIG. 2, the photodetector 8 includes plural detector parts, receiving 0-order light of reflected laser beam having passed through the objective lens 5 by a corresponding detector part (first detector part) and converting to an electrical signal. Similarly the photodetector 8 receives ±1-order light by a corresponding detector part (second detector part) and converts to an electrical signal, and then outputs the converted signals. The CAD focus error signal detection circuit 1711 generates and outputs a focus error signal (first focus error signal) by the CAD method (astigmatism method) corresponding to a focus error amount, by performing an addition or subtraction operation on plural outputs (first outputs) from plural light receiving areas of the detector part (first detector part) in the photodetector 8 that receives the 0-order light. The DAD focus error signal detection circuit 1712 generates and outputs a focus error signal (second focus error signal) by the DAD method (differential astigmatism method) from a signal (first signal) obtained by performing the addition or subtraction operation on the outputs (first outputs) from the detector part (first detector part) that receives the 0-order light, as well as from a signal (second signal) obtained by performing an addition or subtraction operation on plural outputs (second outputs) from plural light receiving areas of the detector part (second detector part) of the photodetector 8 that receives the ±1-order light.

During the recording or reproducing operation on one recording layer of the optical disc 2, the focus jump control circuit 201 within the microcomputer 20 controls the switching circuit 172 so that the switch is turned ON to the B side. In such a state, the focus error signal of the DAD method is supplied to the focus controller 18 from the DAD focus error signal detection circuit 1712 of the reproduction/error signal processor 17. In the focus controller 18, a focus control signal is generated based on the focus error signal of the DAD method, which is then input to the actuator driving circuit 10. The actuator driving circuit 10 performs the focus control of the objective lens 5 by driving the actuator 9 based on the focus control signal.

Further, when the optical disc apparatus 1 performs the focus jump in order to record or reproduce moving from one recording layer to another recording layer in the optical disc 2, the focus jump control circuit 201 controls the switching circuit 172 so that the switch is turned OFF to the B side and ON to the A side. In such a state, the focus error signal of the CAD method is supplied to the focus controller 18 from the CAD focus error signal detection circuit 1711 of the reproduction/error signal processor 17. In the focus controller 18, a focus control signal is generated based on the focus error signal of the CAD method and is input to the actuator driving circuit 10. The actuator driving circuit 10 performs the focus control of the objective lens 5 by driving the actuator 9 based on the focus control signal.

FIG. 3 is a block diagram of focus error signal detection within the photodetector 8 of the optical disc apparatus 1 of FIG. 1.

In FIG. 3, of plural detector parts included in the photodetector 8, reference numeral 81 denotes a detector part (first detector part) for receiving the 0-order light of the reflected laser beam; 82 and 83 denote detector parts (second detector parts) for receiving the ±1-order light of the reflected laser beam; 1711a to 1711c and 1712a to 1712d respectively denote adding circuits; 1712e denotes a coefficient generating circuit for generating a coefficient K; reference symbols A to D denote plural light receiving areas (four areas) of the detector part 81; E1 to E4 denote plural light receiving areas (four areas) of the detector part 82; and F1 to F4 denote plural light receiving areas (four areas) of the detector part 83. The adding circuits 1711a to 1711c constitute the CAD focus error signal detection circuit 1711. Further, the adding circuits 1712a to 1712b and the coefficient generating circuit 1712e constitute the DAD focus error signal detection circuit 1712, in addition to the adding circuits 1711a to 1711c.

The CAD focus error signal detection circuit 1711 generates and outputs a focus error signal (first focus error signal) by the astigmatism method (CAD method) corresponding to the focus error amount by performing an addition or subtraction operation on plural outputs (first outputs) from the plurality of light receiving areas A to D of the first detector part 81 by means of the adding circuits 1711a to 1711c. The DAD focus error signal detection circuit 1712 generates and outputs a focus error signal (second focus error signal) by the differential astigmatism method (DAD method) from the signal (first signal) obtained by performing the addition or subtraction operation on the first outputs by means of the adding circuits 1711a to 1711c, and from a signal (second signal) obtained by performing an addition or subtraction operation or a coefficient multiplication operation on plural outputs (second outputs) from the plurality of light receiving areas E1 to E4 and F1 to F4 of the respective detector parts 82 and 83.

In FIG. 3, assuming that A to D are the signal outputs of the light receiving areas A to D, EF1 is the synthesized signal output from the light receiving areas E1 and F1, EF2 is the synthesized signal output from the light receiving areas E2 and F2, EF3 is the synthesized signal output from the light receiving areas E3 and F3, and EF4 is the synthesized signal output from the light receiving areas E4 and F4:

a focus error signal e₁ by the CAD method is obtained from the adding circuit 1711c, which is expressed by the following equation:

e₁=(A+C)−(B+D) (Equation 1)

while a focus error signal e₂ by the DAD method is obtained from the adding circuit 1712d, which is expressed by the following equations:

e₂=e₁+K·SAD (Equation 2)

={(A+C)−(B+D)}+K·{(EF1−EF2)+(EF3−EF4)} (Equation 3)

where SAD is the output from the adding circuit 1712c.

The switching circuit 172 alternatively switches between the CAD focus error signal detection circuit 1711 including the adding circuits 1711a to 1711c and the DAD focus error signal detection circuit 1712 including the adding circuits 1711a to 1711c, 1712a to 1712d and coefficient generating circuit 1712e. When the recording or reproducing operation is performed on one recording layer, the switching circuit 172 switches to the DAD focus error signal detection circuit 1712 (or it switches the DAD focus error signal detection circuit 1712 to ON state). Thus a supply path of the focus error signal of the DAD method, which has the advantage of not being affected by the leakage from adjacent tracks, is formed to the focus controller 18 side. In the case of the focus jump, the switching circuit 172 switches to the CAD focus error signal detection circuit 1712. Thus a supply path of the focus error signal of the CAD method, which has the advantage of that the signal due to an unnecessary light component between the recording layers is not detected, is formed to the focus controller 18 side.

FIG. 4 is a diagram illustrating the focus jump in the optical disc apparatus 1 of FIG. 1, in which (a) represents a focus error signal waveform and (b) represents a focus drive signal waveform.

In FIG. 4, the focus control is performed using the focus error signal of the DAD method during the recording or reproducing operation on Layer “0” as a first recording layer (Period (1)). The focus control (jump control) in the focus jump is performed using the focus error signal of the CAD method during movement from Layer “0” as the first recording layer to Layer “1” as a second recording layer (Period (2)). Further, the focus control is performed using the focus error signal of the DAD method again during the recording or reproducing operation on Layer “1” as the second recording layer (period (3)). A point p in the focus error signal waveform is the slowdown start point, and a point q is the jump end point.

FIG. 5 is a diagram of the operation of the focus control in the optical disc apparatus 1 of FIG. 1.

In FIG. 5, the steps are as follows:

(1) When the optical disc apparatus 1 is set to a recording or reproduction mode, the photodetector 8 receives the 0-order light and ±1-order light of the reflected laser beam having passed through the objective lens 5, converts the received lights into electrical signals and outputs the converted signals (Step S501).

(2) The CAD focus error signal detection circuit 1711 of the focus error signal detection circuit 171 is controlled by the microcomputer 20 to generate and output a focus error signal of the astigmatism method (CAD method) by performing an addition or subtracting operation on plural outputs based on the 0-order light of the reflected laser beam (Step S502).

(3) The DAD focus error signal detection circuit 1712 of the focus error signal detection circuit 171 is controlled by the microcomputer 20 to generate and output a focus error signal of the differential astigmatism method (DAD method) by performing the addition or subtraction operation on the focus error signal of the astigmatism method (CAD method) as well as on a signal obtained by performing an addition or subtraction operation on plural outputs based on the ±1-order light (Step S503).

(4) The microcomputer 20 controls the switching circuit 172 to switch the DAD focus error signal detection circuit 1712 to ON state, causing the focus error signal of the differential astigmatism method (DAD method) to be input to the focus controller 18. Thus the focus control of the objective lens 5 is performed via the actuator driving circuit 10 and the actuator 9. The optical disc apparatus 1 records or reproduces information onto/from the first recording layer of the optical disc 2 with such a state of the focus control (Step S504).

(5) When the optical disc apparatus 1 moves the recording or reproducing operation on the optical disc 2 from the first recording layer to the second recording layer, the focus jump control circuit 201 within the microcomputer 20 controls the switching circuit 172 in response to a signal instructing the focus jump, to switch the DAD focus error signal detection circuit 1712 to OFF state and the CAD focus error signal detection circuit 1711 to ON state, causing the focus error signal of the astigmatism method (CAD method) to be input to the focus controller 18. Thus the focus control of the objective lens 5 is performed via the actuator driving circuit 10 and the actuator 9. In other words, the focus error signal for the focus control is switched from the focus error signal of the differential astigmatism method (DAD method) to the focus error signal of the astigmatism method (CAD method) (Step S505).

(6) The microcomputer 20 causes the focus of the objective lens 5 to jump from the first recording layer to the second recording layer in the state where the focus control is performed based on the focus error signal of the astigmatism method (CAD method) (Step S506).

(7) The focus jump control circuit 201 within the microcomputer 20 controls the switching circuit 172 in response to an instruction signal to switch the CAD focus error signal detection circuit 1711 to OFF state and the DAD focus error signal detection circuit 1712 to ON state again, causing the focus error signal of the differential astigmatism method (DAD method) to be input to the focus controller 18. Thus the focus control of the objective lens 5 is performed via the actuator driving circuit 10 and the actuator 9. In other words, the focus error signal for the focus control is switched from the focus error signal of the astigmatism method (CAD method) to the focus error signal of the differential astigmatism method (DAD method) (Step S507).

(8) The optical disc apparatus 1 records or reproduces information onto/from the second recording layer of the optical disc 2 in the state where the focus control is performed based on the switched focus error signal of the differential astigmatism method (DAD method) (Step S508).

With the optical disc apparatus 1, it is possible to constantly perform the recording/reproducing operation including the focus jump operation and seek operation of the objective lens 5 relative to the optical disc 2 having plural recording layers.

It is to be noted that the microcomputer 20 is used as a controller in the optical disc apparatus 1 of the above described embodiment, but the present invention is not limited to this configuration. Further in the above described embodiment, the focus jump control circuit 201 is provided within the microcomputer 20, but the present invention is not limited to this configuration, and the focus jump control circuit 201 may be provided outside the microcomputer 20 or may be provided within the focus controller 18.

The present invention can be applied to other embodiments without departing from the sprit or essential characteristics thereof. Thus the above described embodiment is merely an example of the present invention throughout the description, and it should not be understood from a limiting point of view. The scope of the present invention is defined by the appended claims. In addition various changes and modifications belonging to the equivalent scope of the claim are all within the scope of the present invention.

What is claimed is:

1. An optical disc apparatus for recording or reproducing information onto/from a plurality of recording layers of an optical disc by controlling the focus of an objective lens, the optical disc apparatus comprising:
a photodetector that receives 0-order light of a reflected laser beam having passed through the objective lens by a first detector part to convert to an electrical signal, receives ±1-order light of the reflected laser beam by a second detector part to convert to an electrical signal, and outputs the converted electrical signals;
a first focus error signal detection circuit that generates and outputs a first focus error signal of an astigmatism method, corresponding to a focus error amount, by performing an addition or subtraction operation on a plurality of first outputs from a plurality of light receiving areas of the first detector part in the photodetector;
a second focus error signal detection circuit that generates and outputs a second focus error signal of a differential astigmatism method, from a first signal obtained by performing the addition or subtraction operation on the first outputs as well as from a second signal obtained by performing an addition or subtraction operation or a coefficient multiplication operation on a plurality of second outputs from a plurality of light receiving areas of the second detector part;
a selector that selects one of the first focus error detection circuit and the second focus error signal detection circuit; and
a controller that controls the selector,
wherein when a focus jump is performed in response to switching of the recording layer of the optical disc, the controller controls the selector to select the first focus error signal detection circuit to perform the focus control of the objective lens based on the first focus error signal.

2. The optical disc apparatus according to claim 1,
wherein when recording or reproducing information is performed onto/from one recording layer of the optical disc, the controller controls the selector to select the second focus error signal detection circuit to perform the focus control of the objective lens based on the second focus error signal.

3. The optical disc apparatus according to claim 1,
wherein the selector switches connection of a switch in response to an instruction signal from the controller to select one of the first focus error signal detection circuit and the second focus error signal detection circuit.

4. The optical disc apparatus according to claim 2,
wherein the selector switches connection of the switch in response to an instruction signal from the controller to select one of the first focus error signal detection circuit and the second focus error signal detection circuit.

5. An information recording/reproducing method of an optical disc apparatus for recording or reproducing information onto/from a plurality of recording layers of an optical disc by controlling the focus of an object lens, the method comprising:
a first step of receiving 0-order light and ±1-order light of a reflected laser beam having passed through the objective lens, converting to electrical signals respectively, and outputting the converted electrical signals;
a second step of generating and outputting a focus error signal of an astigmatism method by performing an addition or subtraction operation on a plurality of outputs based on the 0-order light of the reflected laser beam;
a third step of generating and outputting a focus error signal of a differential astigmatism method, from the focus error signal of the astigmatism method as well as from a signal obtained by performing an addition or subtraction operation or a coefficient multiplication operation on a plurality of outputs based on the ±1-order light;
a fourth step of recording or reproducing information onto/from a first recording layer of the optical disc by performing focus control of the objective lens based on the focus error signal of the differential astigmatism method;
a fifth step of switching the focus error signal for the focus control from the focus error signal of the differential astigmatism method to the focus error signal of the astigmatism method;
a sixth step of performing a focus jump from the first recording layer to a second recording layer while performing the focus control of the objective lens based on the focus error signal of the astigmatism method;
a seventh step of switching the focus error signal for the focus control from the focus error signal of the astigmatism method to the focus error signal of the differential astigmatism method; and
an eighth step of recording or reproducing information onto/from the second recording layer by performing the focus control of the objective lens based on the focus error signal of the differential astigmatism method,
thereby recording or reproducing information onto/from the first and second recording layers.

6. The information recording/reproducing method of the optical disc apparatus according to claim 5,
wherein the fifth and seventh steps include switching circuits for generating the respective focus error signals in response to an instruction signal.

7. An information recording/reproducing method of an optical disc apparatus for recording or reproducing information by performing focus control by irradiating a laser beam to an optical disc having a plurality of recording layers, the method comprising steps of:
performing the focus control based on a first focus error signal when recording or reproducing information onto/from one recording layer; and
performing the focus control based on a second focus error signal when performing a focus jump to a recording layer other than the one recording layer.

8. The information recording/reproducing method of the optical disc apparatus according to claim 7,
wherein the first focus error signal is generated based on 0-order light of reflected light from the optical disc to which the laser beam is irradiated, and
the second error signal is generated based on the 0-order light and ±1-order light from the optical disc to which the laser beam is irradiated.
